(19) United States
(12) Patent Application Publication
(10) Pub. No.: US 2019/0207776 A1
(43) Pub. Date: Jul. 4, 2019

(54) SESSION MANAGEMENT FOR COMMUNICATIONS BETWEEN A DEVICE AND A DTLS SERVER

(71) Applicant: Futurewei Technologies, Inc., Plano, TX (US)

(72) Inventors: Xiaobo WANG, San Jose, CA (US); Yan LIU, Shenzhen (CN); Honglei WANG, Shenzhen (CN)

(73) Assignee: Futurewei Technologies, Inc., Plano, TX (US)

(21) Appl. No.: 15/858,035

(22) Filed: Dec. 29, 2017

(51) Int. Cl. H04L 12/12; H04L 29/12; H04L 12/46; H04L 9/32; H04L 9/08; H04L 29/06

(52) U.S. Cl. CPC H04L 12/12; H04L 61/2564; H04L 12/4633; H04L 12/4666; H04L 67/12; H04L 9/0861; H04L 63/0428; H04L 63/166; H04L 9/3226

(57) ABSTRACT

A DTLS server receives a first DTLS packet from the device to initiate a DTLS session with the DTLS server, wherein the first DTLS packet is encapsulated in a first UDP packet, a header of the first UDP packet includes a destination port number in an unregistered port number range of 1024 to 49151. In response to receiving the destination port number, the DTLS server assigns a Session ID (SID) for the DTLS session. The DTLS server associates a session key for the DTLS session with the SID. The DTLS server sends a second DTLS packet to the device, wherein the second DTLS packet is encapsulated in a second UDP packet, a header of the second UDP packet includes a source port number set to the destination port number, a payload of the second UDP packet includes the second DTLS packet and carries the SID outside the second DTLS packet.

### BACKGROUND

Internet of Things (IoT) devices are commonly used. Generally an IoT device connects to an DTLS server through Datagram Transport Layer Security (DTLS) protocol. Most of the IoT devices are behind NAT devices and there is a critical problem as below in this scenario. A Network Address Translation (NAT) device creates and maintains a binding for an IoT device, e.g. the binding includes a mapping between a private IP address of the IoT device and a public IP address of the IoT device. Using the public IP address assigned by the NAT device, the IoT device establishes a DTLS session with a DTLS server.

However, the binding on the NAT device will expire once there is no activity/traffic associated with the binding, e.g., the IoT device sleeps in order to save power. When the IoT device wakes up, it will communicate with the DTLS server again. The NAT device assigns a new public IP address to the IoT device to create a new binding. But the DTLS session is still associated with the old public IP address on the DTLS server. The server cannot find the DTLS session using the new public IP address, and then reject the communication. The IoT device has to renegotiate and establish new DTLS session and computing with large amount of renegotiation data significantly exhausts IoT device's power and reduces its battery life.

### SUMMARY

According to one aspect of the present disclosure, a method of session management for communications between a device and a DTLS server is provided. The method includes a DTLS server in communication via a public network with a device on a private network through a Network Address Translation (NAT) device. The DTLS server receives a first DTLS packet from the device to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151. And in response to receiving the destination port number, the DTLS server assigns a Session ID (SID) for the DTLS session between the device and the DTLS server, the SID having a length from 6 bytes to 132 bytes. The DTLS server associates a session key for the DTLS session with the SID. The DTLS server sends a second DTLS packet to the device, wherein the second DTLS packet is encapsulated in a second UDP packet having a header and a payload, the header of the second UDP packet includes a source port number set to the destination port number, and the payload of the second UDP packet includes the second DTLS packet and carries the SID outside the second DTLS packet.

In any preceding aspect, another implementation of the aspect provides that the DTLS server receives a third DTLS packet from the device, wherein the third DTLS packet is encapsulated in a third UDP packet having a header and a payload, the header of the third UDP packet includes the destination port number and the payload of the third UDP packet includes the third DTLS packet and carries the SID outside the third DTLS packet. In response to receiving the destination port number, the DTLS server retrieves the SID from the payload of the third UDP packet. The DTLS server retrieves the session key associated with the SID and authenticates the third DTLS packet using the session key.

In any preceding aspect, another implementation of the aspect provides that the SID includes a first segment and a second segment, and wherein the first segment contains an public IP address assigned by the NAT device to the device and the second segment contains port number and index, wherein the port number assigned by the NAT device to the device, the index is a random value assigned by the DTLS server.

In any preceding aspect, another implementation of the aspect provides that the DTLS server generates an unencrypted SID and encrypts the unencrypted SID to form the SID.

According to one aspect of the present disclosure, a method of session management for communications between a device and a DTLS server is provided. The method includes a device in communication via a private network with a DTLS server on a public network through a NAT device. The device generates a first DTLS packet to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151. The device sends the first DTLS packet to the DTLS server through the NAT device. The device receives a second DTLS packet from the DTLS server in response to the first DTLS packet for initiating a DTLS session, wherein the second DTLS packet is encapsulated in a second UDP packet having a header and a payload, the header of the second UDP packet includes a source port number set to the destination port number and the payload of the second UDP packet includes the second DTLS packet and carries the SID outside the second DTLS packet. The device extracts the SID from the payload of the second UDP packet.

In any preceding aspect, another implementation of the aspect provides that the device generates a third DTLS packet, wherein the third DTLS packet is encapsulated in a third UDP packet having a header and a payload, the header of the third UDP packet includes the destination port number and the payload of the third UDP packet includes the third DTLS packet and carries the SID outside the third DTLS packet. The device sends the third DTLS packet to the DTLS server.

In any preceding aspect, another implementation of the aspect provides that the device enters into a sleep mode and then waking up from the sleep mode and sends a fourth DTLS packet to the DTLS server through the NAT device, wherein the fourth DTLS packet is encapsulated in a fourth UDP packet having a header and a payload, the header of the fourth UDP packet includes the destination port number and the payload of the fourth UDP packet includes the fourth DTLS packet and carries the SID outside the fourth DTLS packet.

According to one aspect of the present disclosure, a DTLS server is provided. The DTLS server includes a non-transitory memory storage comprising instructions; and one or more processors in communicating with the memory, wherein the one or more processors execute the instructions to: receive a first DTLS packet from the device to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151; and in response to receiving the destination port number, assign a Session ID (SID) for the DTLS session between the device and the DTLS server, the SID having a length from 6 bytes to 132 bytes; associate a session key for the DTLS session with the SID; send a second DTLS packet to the device, wherein the second DTLS packet is encapsulated in a second UDP packet having a header and a payload, the header of the second UDP packet includes a source port number set to the destination port number, and the payload of the second UDP packet includes the second DTLS packet and carries the SID outside the second DTLS packet.

In any preceding aspect, another implementation of the aspect provides that the one or more processors further execute the instructions to: receive a third DTLS packet from the device, wherein the third DTLS packet is encapsulated in a third UDP packet having a header and a payload, the header of the third UDP packet includes the destination port number and the payload of the third UDP packet includes the third DTLS packet and carries the SID outside the third DTLS packet; and in response to receiving the destination port number, retrieve the SID from the payload of the third UDP packet; retrieve the session key associated with the SID; authenticate the third DTLS packet using the session key.

In any preceding aspect, another implementation of the aspect provides that the SID includes a first segment and a second segment, and wherein the first segment contains an public IP address assigned by the NAT device to the device and the second segment contains port number and index, wherein the port number assigned by the NAT device to the device, the index is a random value assigned by the DTLS server.

In any preceding aspect, another implementation of the aspect provides that the one or more processors further execute the instructions to: generate an unencrypted SID and encrypt the unencrypted SID to form the SID.

### BRIEF DESCRIPTION OF THE DRAWINGS

FIG. 1 is an example of a system on which embodiments according to the present disclosure can be implemented.

FIG. 2A and FIG. 2B illustrate a process in an embodiment according to the present disclosure.

FIG. 3A illustrates a packet encapsulation format used to encapsulate a DTLS session initiating message according to an embodiment of the present disclosure.

FIG. 3B illustrates a packet encapsulation format used to encapsulate a DTLS packet according to an embodiment of the present disclosure.

FIG. 3C illustrates another packet encapsulation format used to encapsulate a DTLS packet according to an embodiment of the present disclosure.

FIG. 3D illustrates a protocol stack implemented in an embodiment of the present disclosure.

FIG. 3E illustrates a SID structure according to the present disclosure.

FIG. 4 is a block diagram of a computing device that may be used to implement embodiments according to the present invention.

### DETAILED DESCRIPTION

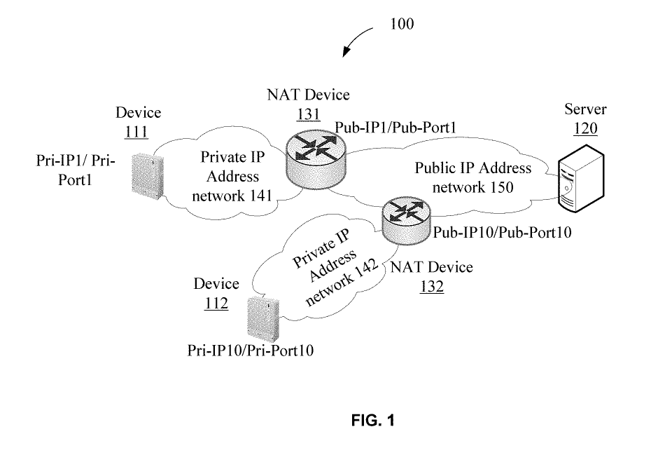

FIG. 1 is a system 100 on which embodiments according to the present disclosure can be implemented. In an embodiment, the system 100 is an example of a server in communication via a public network with devices on a private network through a Network Address Translation (NAT) device.

In the example of FIG. 1, the system 100 includes devices 111 and 112, NAT devices 131 and 132, a server 120, private IP address networks 141 and 142, and a public IP address network 150. The device 111 is in the private IP address network 141 and behind the NAT device 131. The device 111 has a private IP address 1 (Pri-IP1) and/or a private port number 1 (Pri-Port1) and it communicates via the NAT device 131 with the Server 120 on the public IP address network 150. The NAT device 131 assigns a public IP address 1 (Pub-IP1) and/or a public port number 1 (Pub-Port1) for the device 111 and creates and maintain a binding between the Pri-IP1 and Pub-IP1 and/or between the Pri-Port1 and Pub-Port1.

The device 112 is in the private IP address network 142 and behind the NAT device 132. The device 112 communicates via the NAT device 132 with the Server 120 on the public IP address network 150. The device 112 is in the private IP address network 142 and behind the NAT device 132. The device 112 has a private IP address 10 (Pri-W10) and/or a private port number 10 (Pri-Port10) and it communicates via the NAT device 132 with the Server 120 on the public IP address network 150. The NAT device 132 assigns a public IP address 10 (Pub-W10) and/or a public port number 10 (Pub-Port10) for the device 112 and creates and maintain a binding between the Pri-IP10 and Pub-W10 and/or between the Pri-Port10 and Pub-Port10.

The device 111 and 112 are not only resource constrained (e.g., Battery power) devices but also have long lifetime. For example, the device 111 and 112 are devices in IoT network (be called IoT devices), e.g., physical devices, vehicles, home appliances, and other items embedded with electronics, software, sensors. The server 120 provides IoT applications and is called DTLS server. In order to make sure communication security, IoT application layer protocol, e.g., constrained application protocol (CoAP), uses DTLS as the security protocol for communication and authentication between the IoT devices and the DTLS server. From the viewpoint of DTLS protocol, the server is also called a DTLS server.

In the prior art, when the IoT device 111 wants to establish a DTLS session with the DTLS server 120 via the NAT device 131, the DTLS server 120 will use the Pub-IP1 and/or Pub-Port1 to associate with a DTLS session index for the DTLS session. Once receiving a DTLS packet from the IoT device 111, the DTLS server 120 will use the Pub-IP1 and/or Pub-Port1 to look for and acquire the DTLS session index associate with the DTLS session, and then process the DTLS packet, e.g., acquire a session key of the DTLS session and authenticate the DTLS packet using the session key. However, if the NAT binding expires, the NAT device assigns a new public IP address and/or port number to the IoT device 111. But the DTLS session index is still associated with the old Pub-IP1 and/or Pub-Port1 on the DTLS server 120. The DTLS server 120 cannot find the right DTLS session index using the new public IP address and/or port number, and then reject the communication. The IoT device 111 has to renegotiate and establish new DTLS session and computing with large amount of renegotiation data significantly exhausts the power of the IoT device 111 and reduces its battery life.

To solve the problem identified above, according to the present disclosure, the DTLS server 120 will assign a session identifier (SID) for the DTLS session, and send the SID to the IoT device 111. The DTLS session index is now associated with the SID. When the IoT device 111 communicates with the DTLS server 120, the DTLS packet sent by the device 111 will include the SID. When the DTLS server 120 receives the DTLS packet from the device 111, it will use the SID carried in the DTLS packet to find the corresponding DTLS session index and then process the DTLS packet. In this way, the DTLS session index is no longer associated with the public IP address and port number of the device 111. Thus, even if the public IP address and port number assigned to the device are changed due to the NAT binding expiration, the DTLS session still continues because the SID can be used to look for the DTLS session index.

Therefore, after the NAT binding on the NAT device 131 expires and the IoT device 111 needn't to send DTLS re-negotiation messages (e.g., DTLS handshake messages) to the DTLS server 120. This avoids re-negotiation message exchanges and the IoT device 111 doesn't need to process the re-negotiation message exchanges. So the power of the IoT device 111 is saved.

In addition, the present disclosure uses a new DTLS-NAT port number for the device 111 to tell the DTLS server 120 to assign a SID to the DTLS session.

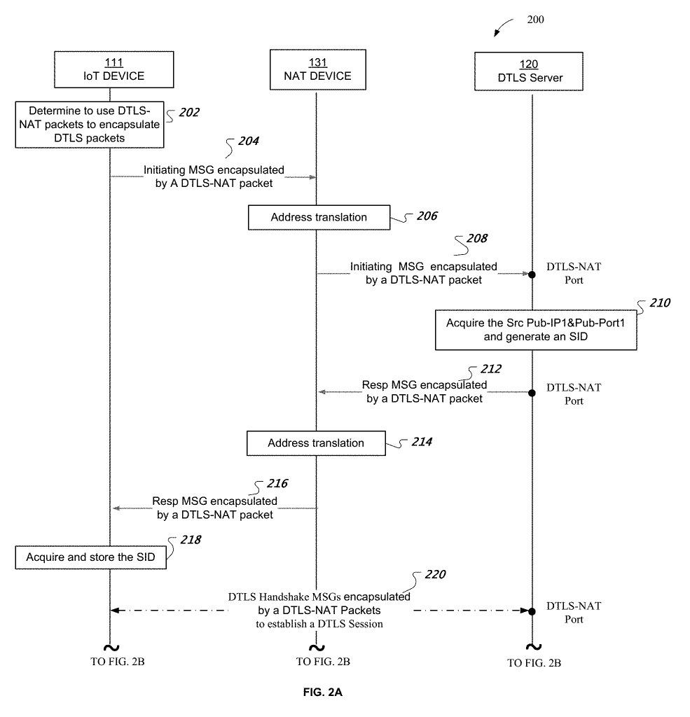

FIG. 2A and FIG. 2B illustrates a flowchart 200 of a process in an embodiment according to the present disclosure. More specifically, FIG. 2A and FIG. 2B together show a diagram showing a sequence of actions and interactions among an IoT device 111, a NAT device 131 and an DTLS server 120, in an embodiment according to the present disclosure.

When the IoT device 111 wants to establish a DTLS session with the DTLS server 120, it first determines whether it needs DTLS-NAT packets to encapsulate DTLS packets according to manual configuration or using a STUN service. For example, in a STUN service scenario, the IoT device 111 sends a connectivity check message to the DTLS server 120. The DTLS server 120 acquires a source IP address and a source Port number in the IP packet and UDP packet which encapsulate the connectivity check message and then sends back the source IP address and the source Port number to the IoT device 111. After receiving the source IP address and the source Port number, the IoT device 111 determines whether the source IP address and the source Port number are equal to Pri-IP1 and Pri-Port1 of the IoT device 111. When the source IP address and the source Port number are equal to Pri-IP1 and Pri-Port1 of the IoT device 111, the IoT device 111 determine that there isn't a NAT device between the IoT device 111 and the DTLS server 120. Otherwise, when the source IP address and the source Port number are not equal to Pri-IP1 and Pri-Port1 of the IoT device 111, the IoT device 111 determines that there is a NAT device between the IoT device 111 and the DTLS server 120 and needs a DTLS-NAT service.

If the IoT device 111 determines that it needs DTLS-NAT packets to encapsulate DTLS packets at step 202, it will generate and send a DTLS session initiating message (initiating MSG) encapsulated in a DTLS-NAT packet to the DTLS server 120 at step 204, wherein the DTLS session initiating message is used to initiate the DTLS session with the DTLS server 120 e.g., the DTLS session initiating message is a Client Hello message. The DTLS session initiating message is the first DTLS packet between the device 111 and the DTLS server 120. Otherwise, the device 111 will send the DTLS session initiating message without encapsulating in a DTLS-NAT packet to the DTLS server 120.

The DTLS session initiating message is encapsulated in a first UDP packet. A header of the first UDP packet includes a destination port (DesPort) number which is the DTLS-NAT port number. For example, the DTLS-NAT port number is an unregistered port number selected from 1024 to 49151. The header of the first UDP packet also includes a source port (SrcPort) and the source port number is above-mentioned Pri-Port1 of the IoT device 111. The first UDP packet is furthermore encapsulated in a first IP packet and a header of the first IP packet includes a source IP address (SrcIP) which is the above-mentioned Pri-IP1 of the IoT device 111.

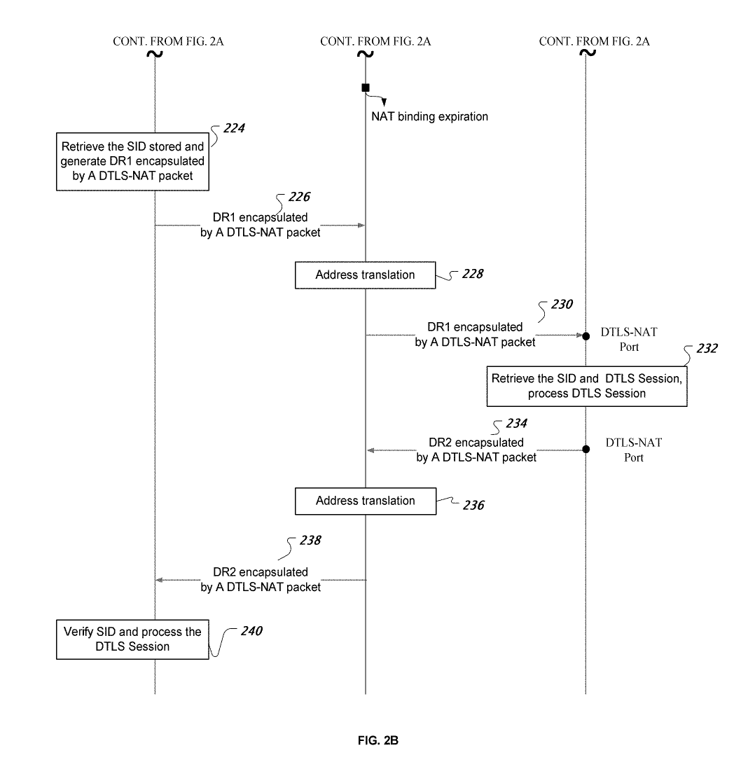

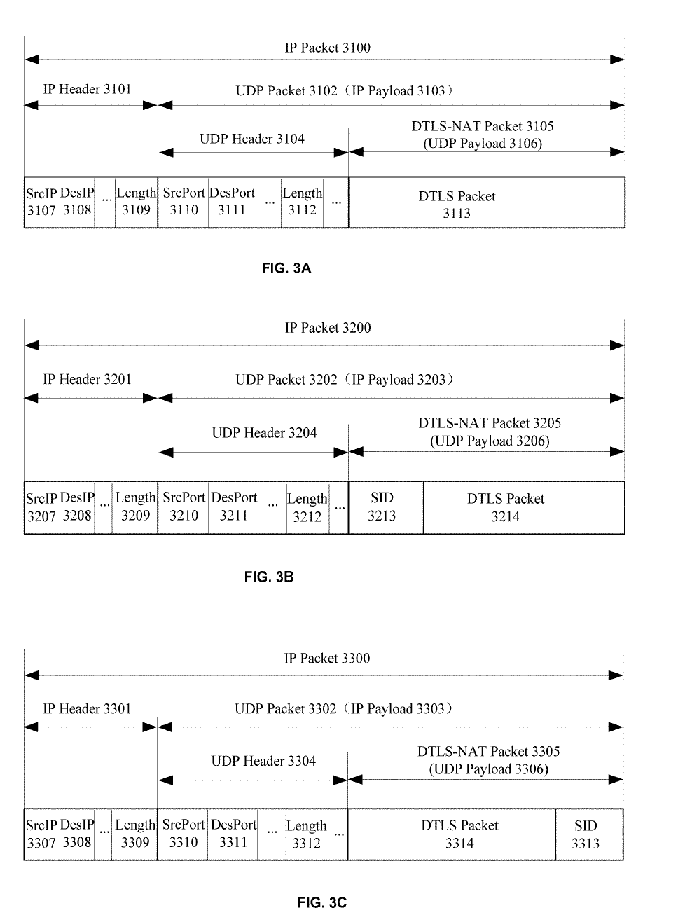

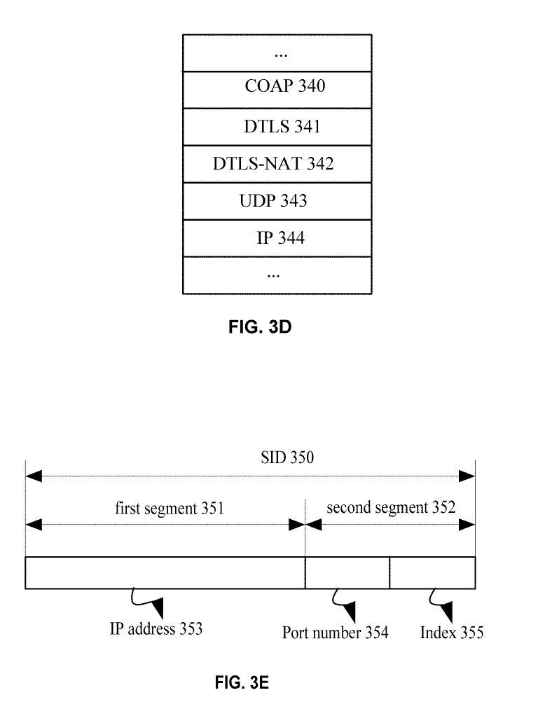

The DTLS-NAT port number indicates the DTLS-NAT port which is used for the DTLS-NAT service. The DTLS-NAT service is a service that uses a DTLS-NAT packet to encapsulate a DTLS packet in the scenario of an IoT device in communication via a private network with a DTLS server on a public network through a NAT device. As shown in FIG. 3D, the DTLS-NAT 342 service layer is on the UDP 343 layer and under the DTLS 341 layer. That is, the DTLS-NAT packet is encapsulated by the UDP packet and the DTLS packet is encapsulated by the DTLS-NAT packet.

A packet encapsulation format (structure) used to encapsulate the DTLS session initiating message is shown in FIG. 3A. The field of the DTLS Packet 3113 is used to carry the DTLS session initiating message. The field of the UDP Header 3104 is used to carry the header of the first UDP packet. The field of the DesPort 3111 is used to carry the DTLS-NAT port number. The field of the SrcPort 3110 is used to carry the Pri-Port1 of the IoT device 111. The field of the UDP Packet 3102 is used to carry the first UDP packet. The field of the IP Header 3101 is used to carry the header of the first IP packet and the field of the IP Packet 3100 is used to carry the first IP packet. The field of the SrcIP 3107 is used to carry the Pri-IP1 of the IoT device 111. In the situation that the DTLS packet is the initiating MSG, the UDP payload 3206 is the DTLS-NAT packet 3205 and the DTLS-NAT packet 3205 is also the DTLS packet 3214.

The IoT device 111 sends the DTLS session initiating message (initiating MSG) to NAT device 131 at step 204. As shown in the above-mentioned description of FIG. 1, the NAT device 131 creates and maintains a binding between the Pri-IP1 and Pub-IP1 and between the Pri-Port1 and Pub-Port1. After receiving the DTLS session initiating message, the NAT device 131 translates respectively the Pri-IP1 and Pri-Port1 to the Pub-IP1 and Pub-Port1 according to the binding at step 206. Then, the NAT device 131 sends the DTLS session initiating message encapsulated in the first UDP and IP packets to the DTLS server 120 at step 208.

The DTLS server 120 receives the DTLS session initiating message encapsulated in first UDP and IP packets and extracts and acquires the DTLS-NAT port number (DesPort), the Pub-IP1 (SrcIP) and the Pub-Port1 (SrcPort) at step 210. The DTLS server 120 determines the received DTLS packet is the DTLS session initiating message, and then determines that the destination port number (DTLS-NAT port number) indicates the DTLS server 120 to assign a Session ID (SID) for a DTLS session between the IoT device 111 and the DTLS server 120.

The method of determining if a received DTLS packet is the DTLS session initiating message includes:

Method 1: the DTLS server 120 acquires and analyzes a message type of the received DTLS packet. If the message type is Client Hello message, the DTLS server 120 determines the received DTLS packet is the DTLS session initiating message. If the message type is not Client Hello message, the received DTLS packet is not the DTLS session initiating message and it is a data record packet or a handshake message except the DTLS session initiating message.

Method 2: the DTLS server 120 compares a length of the payload of the first UDP packet with a length of the received DTLS packet. If the DTLS server 120 determines the length of the payload of the first UDP packet is equal to the length of the received DTLS packet, the received DTLS packet is the DTLS session initiating message. If the DTLS server 120 determines the length of the payload of the first UDP packet is greater than the length of the received DTLS packet, the received DTLS packet is not the DTLS session initiating message and it is a data record packet or a handshake message except the DTLS session initiating message. For example, the header of the first UDP packet includes a length value and the length of the payload of the first UDP packet is equal to the length value in the header of the first UDP packet minus a length of the header of the first UDP packet. A header of the first DTLS packet includes a length value and the length of the first DTLS packet is equal to the length value in the header of the first DTLS packet plus a length of the header of the first DTLS packet.

The DTLS server 120 generates or assigns an SID according to the DTLS-NAT port number and then associates a session key for the DTLS session with the SID at step 210. A detailed description of the DTLS-NAT port number, see above step 202 and FIG. 3A. For brevity, not repeat them here.

As shown in FIG. 3E, the SID is a segmented value and indicates the DTLS session between the IoT device 111 and the DTLS server 120 and includes a first segment and a second segment. For example, the first segment is the public IP address (e.g., Pub-IP1) of the IoT device 111. The public IP address is an IPv4 address/IP prefix whose length is 3˜4 bytes, or an IPv6 address whose length is 128 bytes, or an hash compressed IPv6 address whose length is 3˜128 bytes. The hash compressed IPv6 address is generated by using hash algorithm to compress an IPv6 address whose length is 128 bytes. The second segment is composed of the public port number (e.g., Pub-Port1) of the IoT device 111 and an index. The index is a unique value, e.g., a timestamp value carried in the first IP packet or a counter value, and so on. The length of the second segment is, e.g., 3˜4 bytes. Therefore, the length of the SID is from 6 bytes to 132 bytes.

The segmented SID assignment mechanism makes SID assignment more balanced and ensures no conflicts. For example, as shown in FIG. 1, the IoT device 111 wants to establish DTLS session 1 with the DTLS server 120 and the DTLS server 120 assigns SID 1 for the DTLS session 1. The first segment of the SID 1 is assigned as the Pub-IP1 which is used for IoT devices in the private IP address network 141. The second segment of the SID 1 is assigned as combination of the Pub-Port1 and index 1. And the IoT device 112 wants to establish DTLS session 2 with the DTLS server 120 and the DTLS server 120 assigns SID 2 for the DTLS session 2. The first segment of the SID 2 is assigned as the Pub-IP10 which is used for IoT devices in the private IP address network 142. The second segment of the SID 2 is assigned as combination of the Pub-Port10 and index 2. So, the first segment of the SID indicates the network area that the IoT device belongs to. The first segment of the SID 1 indicate the SID 1 is for IoT devices in the private IP address network 141 area. The first segment of the SID 2 indicate the SID 2 is for IoT devices in the private IP address network 142 area. Therefore, the first segment of the SID makes the SID is assigned balancedly for every private IP address network. The first segment of the SID avoids all the SID resource to be assigned to IoT devices that are located in a few private IP address networks and IoT devices located in the other private IP address networks cannot get enough SID resource. For example, if the SID is not be segmented, and is a flat construction, all the SID resources can be assigned to IoT devices which are located in only a few private IP address network, e.g., private IP address network 141, and the SID resources are exhausted in the private IP address network 141 so that there are no any SID resources can be assigned to IoT devices located in the other private IP address network, e.g., private IP address network 142. In addition, based on the first segment of the SID determines network area (e.g., private IP address network 141), the second segment of the SID furthermore will be assigned to IoT devices in the network area. So, the second segment of the SID ensures no SID resource conflicts in the network area.

In addition, the length of the SID is from 8 bytes to 132 bytes and it's a moderate length. The length is not too long so that IoT devices needn't to consume a lot of power to handle long bytes SID. So, the moderate length of the SID saves power and battery life. What's more, the length of the SID is not too short so that SID resource can be assigned to enough numbers of IoT devices without conflicts and ensures normal business deployment. Therefore, the moderate length of the SID not only saves the power to handle the SID but also ensures without resource conflicts.

In a possible embodiment, the SID is furthermore encrypted by some algorithm. In this case, the DTLS server 120 furthermore generates an encryption key (Kn) and then generates an encrypted SID according to the SID, the Kn and encryption algorithm. The equation is: the encrypted SID=Encryption algorithm (SID, Kn). The encryption algorithm is, e.g., Advanced Encryption Standard counter mode (AES CTR) or Advanced Encryption Standard Galois/Counter Mode (AES GCM), and so on. Encrypting the SID can avoid that an attacker tracks the IoT device by eavesdropping and protect privacy.

The DTLS server 120 generates a response message (Resp MSG) in response to the DTLS session initiating message and sends it to NAT device 131 at step 212. The response message is the second DTLS packet between the device 111 and the DTLS server 120, e.g., Server Hello message. The response message and the SID constitute a second DTLS-NAT packet and the second DTLS-NAT packet is encapsulated in a second UDP packet. The SID can be located in front of the DTLS packet (as shown in FIG. 3B) or at the end of the DTLS packet (as shown in FIG. 3C). A header of the second UDP packet includes a source port (SrcPort) number and which is the DTLS-NAT port number. The header of the second UDP packet also includes a destination port (DesPort) number and the DesPort number is above-mentioned Pub-Port1 of the IoT device 111. The second UDP packet is furthermore encapsulated in a second IP packet, and a header of the second IP packet includes a destination IP address (DesIP) which is the above-mentioned Pub-IP1 of the IoT device 111.

It's worth noting that in a possible embodiment, if the SID has been encrypted, the payload of the second UDP will includes the response message and the encrypted SID. The payload of the second UDP is also the second DTLS-NAT packet.

A packet encapsulation format (structure) used to encapsulate the response message is shown in FIG. 3B. The field of the DTLS Packet 3213 is used to carry the response message. The field of the SID 3214 is used to carry the SID. The field of the DTLS-NAT Packet 3205 is used to carry the SID and the response message. The field of the UDP Header 3204 is used to carry the header of the second UDP packet. The field of the SrcPort 3210 is used to carry the DTLS-NAT port number. The field of the DesPort 3211 is used to carry the Pub-Port1 of the IoT device 111. The field of the UDP Packet 3202 is used to carry the second UDP packet. The field of the IP Header 3201 is used to carry the header of the second IP packet and the field of the IP Packet 3200 is used to carry the second IP packet. The field of the DesIP 3208 is used to carry the Pub-IP1 of the IoT device 111.

FIG. 3C shows another packet encapsulation format (structure) used to encapsulate the response message. FIG. 3C is similar with the FIG. 3B and the only difference is the different location of the SID. FIG. 3B shows the SID is encapsulated in front of the second DTLS packet (the response message) and FIG. 3C shows the SID is encapsulated at the end of the second DTLS packet (the response message). In FIG. 3C, the field of the DTLS Packet 3313 is used to carry the response message. The field of the SID 3314 is used to carry the SID. Please see above description of FIG. 3B for more details. For brevity, not repeat them here.

After receiving the response message, the NAT device 131 translates respectively the Pub-IP1 and Pub-Port1 to the Pri-IP1 and Pri-Port1 according to the binding at step 214. Then, the NAT device 131 sends the response message encapsulated in the second UDP and IP packets to the IoT device 111 at step 216.

The IoT device 111 receives the response message and extracts the SID according to the DTLS-NAT port number from the second UDP payload at step 218. In case of the IoT device 111 determines that there is not an SID stored locally which is the same as the SID encapsulated in the second UDP packet, stores the SID locally. Then the IoT device 111 processes the response message (Resp MSG). For example, specifically, the DTLS protocol stack software on the IoT device 111 processes the response message.

It's worth noting that in a possible embodiment, if the response message carries the encrypted SID, the encrypted SID will be extracted and stored locally.

The IoT device 111 continues to exchange following DTLS handshake messages with DTLS server 120 through NAT device 131 at step 220. For example, the following DTLS handshake messages are Key Exchange message, Change Cipher Spec message, Finished message, and so on. All the following DTLS handshake messages are encapsulated in DTLS-NAT packets. This disclosure takes two of the following DTLS handshake messages as an example to introduce as below. The two example handshake messages are a third handshake message and a fourth handshake message.

The IoT device 111 retrieves (acquires) the SID for the DTLS session and generates the third handshake message (e.g., Key Exchange message) encapsulated in a third DTLS-NAT packet. In the same way as above-mentioned, the third handshake message is encapsulated in a third UDP and IP packets. A packet encapsulation format (structure) used to encapsulate the third handshake message is similar with the above-mentioned encapsulation format of the response message, as shown in FIG. 3B or 3C. About FIGS. 3B and 3C, please see above description of the response message section for more details. For brevity, not repeat them here. The difference is that a value of a field is different. In the case of the third handshake, the value of the SrcPort 3210/3310 is port number on the IoT device 111 and the value of the DesPort 3211/3311 field is DTLS-NAT port number. The value of the SrcIP field is Pri-IP 1 of the IoT device 111 and the value of the DesIP field is IP address on the DTLS server 120.

The IoT device 111 sends the third handshake message encapsulated in the third UDP and IP packets to the NAT device 131. The NAT device 131 translates respectively the Pri-IP1 and Pri-Port1 to the Pub-IP1 and Pub-Port1 according to the binding at step 206 or 214. The NAT device 131 sends the third handshake message encapsulated in the third UDP and IP packets to DTLS server 120.

After receiving the third handshake message encapsulated in the third UDP and IP packets, the DTLS server 120 decapsulates and retrieves (acquires) DTLS-NAT port number. The DTLS server 120 determines the received DTLS packet is not the DTLS session initiating message, and then determines that the destination port number (DTLS-NAT port number) indicates the DTLS server 120 to retrieve the SID in the front of the payload of the third UDP (as shown in FIG. 3B, in front of the third handshake message) or at the end of the payload of the third UDP (as shown in FIG. 3C, behind the third handshake message). About the method of determining if a received DTLS packet is the DTLS session initiating message, please see above description of step 210 for more details. For brevity, not repeat them here. The DTLS server 120 then retrieves the session key associated with the SID, and then authenticate the third handshake message (DTLS packet) using the session key. Then DTLS server 120 processes the third handshake message. For example, specifically, The DTLS protocol stack software on the DTLS server 120 processes the third handshake message.

It's worth noting that in a possible embodiment, the third UDP carries the encrypted SID. The DTLS server 120 furthermore unencrypts the encrypted SID and acquires the SID (unencrypted SID). The DTLS server 120 retrieves the session key associated with the SID, and then authenticate the third handshake message (DTLS packet) using the session key For example, specifically, The DTLS protocol stack on the DTLS server 120 processes the third handshake message.

The DTLS server 120 generates and sends a fourth handshake message to the NAT device 131. In the same way as above-mentioned response message section, the third handshake message is encapsulated in a fourth UDP and IP packets. A packet encapsulation format (structure) used to encapsulate the fourth handshake message is similar with the above-mentioned encapsulation format of the response message, as shown in FIG. 3B or 3C. About FIGS. 3B and 3C, please see above description of the response message section for more details. For brevity, not repeat them here. The difference is that a value of a field is different. In the case of the fourth handshake, the value of the SrcPort 3210/3310 field is the DTLS-NAT port number and the value of the DesPort 3211/3311 field is the above-mentioned Des Pub-Port1. The value of the SrcIP 3207/3307 field is IP address on the DTLS server 120 and the value of the DesIP 3208/3308 field is Pub-IP1 of the IoT device 111.

The NAT device 131 translates respectively the Des Pub-IP1 and Des Pub-Port1 to the Des Pri-IP1 and Des Pri-Port1 according to the binding at step 206 or 214. The NAT device 131 sends the fourth handshake message encapsulated in a fourth UDP and IP packets.

The IoT device 111 receives the fourth handshake message encapsulated in the fourth UDP and IP packets and retrieves (acquires) the SID and determines that there is an SID stored locally which is the same as the SID carried in the fourth UDP packet, the verification will pass. Then IoT device 111 processes the fourth DTLS packet. For example, specifically, The DTLS protocol stack on the IoT device 111 processes the fourth handshake message.

It's worth noting that in a possible embodiment, if the fourth UDP carries the encrypted SID, the encrypted SID will be extracted.

In the same way as above-mentioned step 220, the DTLS session between the IoT device 111 and the DTLS server 120 is established after exchanging all the DTLS handshake messages. That is, each DTLS handshake message is encapsulated as shown in FIG. 3B or 3C. If one of the messages is from the IoT device 111 to the DTLS server 120, the value of the SrcPort 3210/3310 is port number on the IoT device and the value of the DesPort 3211/3311 field is the DTLS-NAT port number. If one of the messages is from the DTLS server 120 to the IoT device 111, the value of the SrcPort 3210/3310 is the DTLS-NAT port number and the value of the DesPort 3211/3311 field is port number on the IoT device. For brevity, not repeat them here please refer to above-mentioned steps 202˜220.

After the DTLS session establishment, if the IoT device 111 enters into sleep mode and the NAT binding on the NAT device 131 expires. And then some time later, IoT device 111 wakes up to send next DTLS packets.

The IoT device 111 retrieves (acquires) the SID for the DTLS session and generates a fifth DTLS packet, e.g., a first Data Record (DR 1) packet encapsulated in a fifth DTLS-NAT packet. In the same way as above-mentioned, the DR 1 is encapsulated in a fifth UDP and IP packets. A packet encapsulation format (structure) used to encapsulate the DR1 is similar with the above-mentioned encapsulation format of the response message, as shown in FIG. 3B or 3C. About FIGS. 3B and 3C, please see above description of the response message section for more details. For brevity, not repeat them here. The difference is that a value of a field is different. In the case of the DR1, the value of the SrcPort 3210/3310 is port number on the IoT device 111 and the value of the DesPort 3211/3311 field is DTLS-NAT port number. The value of the SrcIP field is Pri-IP 1 of the IoT device 111 and the value of the DesIP field is IP address on the DTLS server 120.

The IoT device 111 sends the DR 1 encapsulated in the fifth UDP and IP packets to the NAT device 131. The NAT device 131 translates respectively the Pri-IP1 and Pri-Port1 to the Pub-IP1 and Pub-Port1 according to the binding at step 206 or 214. The NAT device 131 sends the DR 1 encapsulated in the fifth UDP and IP packets to DTLS server 120.

After receiving the DR 1 encapsulated in the fifth UDP and IP packets, the DTLS server 120 decapsulates and retrieves (acquires) DTLS-NAT port number. The DTLS server 120 determines the received DTLS packet is not the DTLS session initiating message, and then determines that the destination port number (DTLS-NAT port number) indicates the DTLS server 120 to retrieve the SID in the front of the payload of the fifth UDP (as shown in FIG. 3B, in front of the DR 1) or at the end of the payload of the fifth UDP (as shown in FIG. 3C, behind the DR 1). About the method of determining if a received DTLS packet is the DTLS session initiating message, please see above description of step 210 for more details. For brevity, not repeat them here. The DTLS server 120 retrieves the session key associated with the SID, and then authenticates the DR 1 (DTLS packet) using the session key. Then DTLS server 120 processes the DR1. For example, specifically, The DTLS protocol stack software on the DTLS server 120 processes the DR 1.

It's worth noting that in a possible embodiment, the fifth UDP carries the encrypted SID. The DTLS server 120 furthermore unencrypts the encrypted SID and acquires the SID (unencrypted SID). The DTLS server 120 retrieves the session key associated with the SID, and then authenticate the DR1 (DTLS packet) using the session key For example, specifically, The DTLS protocol stack on the DTLS server 120 processes the DR1.

The DTLS server 120 generates and sends a DR2 to the NAT device 131. In the same way as above-mentioned response message section, the DR2 is encapsulated in a sixth UDP and IP packets and the encapsulation structure. A packet encapsulation format (structure) used to encapsulate the DR2 is similar with the above-mentioned encapsulation format of the response message, as shown in FIG. 3B or 3C. About FIGS. 3B and 3C, please see above description of the response message section for more details. For brevity, not repeat them here. The difference is that a value of a field is different. In the case of the DR2, the value of the SrcPort 3210/3310 field is the DTLS-NAT port number and the value of the DesPort 3211/3311 field is the above-mentioned Des Pub-Port1. The value of the SrcIP 3207/3307 field is IP address on the DTLS server 120 and the value of the DesIP 3208/3308 field is Pub-IP1 of the IoT device 111.

The NAT device 131 translates respectively the Des Pub-IP1 and Des Pub-Port1 to the Des Pri-IP1 and Des Pri-Port1 according to the binding at step 206 or 214. The NAT device 131 sends the DR 2 encapsulated in a sixth UDP and IP packets.

The IoT device 111 receives the DR2 encapsulated in the sixth UDP and IP packets and retrieves (acquires) the SID and determines that there is an SID stored locally which is the same as the SID carried in the sixth UDP packet, the verification will pass. Then IoT device 111 processes the DR2. For example, specifically, The DTLS protocol stack on the IoT device 111 processes the DR2.

It's worth noting that in a possible embodiment, if the sixth UDP carries the encrypted SID, the encrypted SID will be extracted.

As shown in the above-mentioned step 202˜240, after the NAT binding on the NAT device 131 expires and IoT device 111 wakes up, the IoT device 111 needn't to send DTLS re-negotiation messages (e.g., DTLS handshake messages) to the DTLS server 120. So, this method avoids re-negotiation message exchanging and saves the power of the IoT device 111.

In addition, the present disclosure uses a new UDP port (called DTLS-NAT port) to provide a DTLS-NAT service. The DTLS-NAT service uses a UDP payload to encapsulate the SID and the DTLS packet. So, the present disclosure doesn't need to extend and change DTLS standard specification and avoids lots of work of standardization.

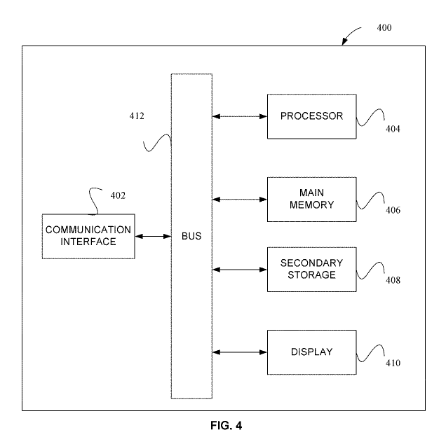

FIG. 4 is a block diagram of an example of a computing device 400 capable of implementing embodiments according to the present invention. The device 400 broadly includes any single or multi-processor computing device or system capable of executing computer-readable instructions, such as those described in conjunction with FIG. 2A and FIG. 2B. That is, the device 400 is implemented as the IoT device 110 or as the DTLS server 120 (FIG. 1), for example. In its most basic configuration, the device 400 may include at least one communication interface (e.g., the interface 402), at least one processing circuit (e.g., the processor 404) and at least one non-volatile storage medium (e.g., the memories 406 and 408), each of which may be interconnected via a communication bus 412.

The processor 404 of FIG. 4 generally represents any type or form of processing unit or circuit capable of processing data or interpreting and executing instructions. In certain embodiments, the processor 404 may receive instructions from a software application or module. These instructions may cause the processor 404 to perform the functions of one or more of the example embodiments described and/or illustrated herein.

The main memory 406 includes, for example, random access memory (RAM). The secondary storage 408 includes, for example, a hard disk drive and/or a removable storage drive, representing a floppy disk drive, a magnetic tape drive, a compact disk drive, etc. The removable storage drive reads from and/or writes to a removable storage unit in a well known manner. The memory or the storage includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that is used to store the desired information and that is accessed to retrieve that information.

Computer programs, or computer control logic algorithms, is stored in the main memory 406, the secondary storage 408, and/or any other memory, for that matter. Such computer programs, when executed, enable the device 400 to perform various functions (as set forth above, for example).

The device 400 also includes one or more components or elements in addition to the processor 404 and the system memories 406, and 408. For example, the device 400 includes an input/output (I/O) device, and a display 410, each of which is interconnected via the system bus 412.

The communication interface 402 broadly represents any type or form of communication device or adapter capable of facilitating communication between the device 400 and one or more other devices such as but not limited to routers and edge routers. The communication interface 402 includes, for example, a receiver and a transmitter that are used to receive and transmit information (wired or wirelessly) such as, but not limited to, the SID and the DTLS-NAT packets in a scenario that a server in communication via a public network with devices on a private network through a Network Address Translation (NAT) device.

The device 400 executes an application that allows it to perform operations (e.g., the operations of FIG. 2A and FIG. 2B). A computer program containing the application is loaded into the device 400. For example, all or a portion of the computer program stored on a computer-readable medium is stored in the memory 406 or 408. When executed by the processor 404, the computer program causes the processor to perform and/or is a means for performing the functions of the example embodiments described and/or illustrated herein. Additionally or alternatively, the example embodiments described and/or illustrated herein may be implemented in server and/or hardware.

While the foregoing disclosure sets forth various embodiments using specific block diagrams, flowcharts, and examples, each block diagram component, flowchart step, operation, and/or component described and/or illustrated herein is implemented, individually and/or collectively, using a wide range of hardware, software, or server (or any combination thereof) configurations. In addition, any disclosure of components contained within other components should be considered as examples because many other architectures are implemented to achieve the same functionality.

The process parameters and sequence of steps described and/or illustrated herein are given by way of example only and are varied as desired. For example, while the steps illustrated and/or described herein may be shown or discussed in a particular order, these steps do not necessarily need to be performed in the order illustrated or discussed. The various example methods described and/or illustrated herein also omits one or more of the steps described or illustrated herein or include additional steps in addition to those disclosed.

While various embodiments have been described and/or illustrated herein in the context of fully functional computing systems, one or more of these example embodiments is/are distributed as a program product in a variety of forms, regardless of the particular type of computer-readable media used to actually carry out the distribution. The embodiments disclosed herein are also implemented using software modules that perform certain tasks. These software modules include script, batch, or other executable files that may be stored on a computer-readable storage medium or in a computing system. These software modules configure a computing system to perform one or more of the example embodiments disclosed herein.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosed disclosure.

What is claimed is:

1. A method performed by a Datagram Transport Layer Security (DTLS) server in communication via a public network with a device on a private network through a Network Address Translation (NAT) device, comprising:
receiving a first DTLS packet from the device to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151; and
in response to receiving the destination port number, assigning a Session ID (SID) for the DTLS session between the device and the DTLS server, the SID having a length from 6 bytes to 132 bytes;
associating a session key for the DTLS session with the SID;
sending a second DTLS packet to the device, wherein the second DTLS packet is encapsulated in a second UDP packet having a header and a payload, the header of the second UDP packet includes a source port number set to the destination port number, and the payload of the second UDP packet includes the second DTLS packet and carries the SID outside the second DTLS packet.

2. The method according to claim 1, the method further comprising:
receiving a third DTLS packet from the device, wherein the third DTLS packet is encapsulated in a third UDP packet having a header and a payload, the header of the third UDP packet includes the destination port number and the payload of the third UDP packet includes the third DTLS packet and carries the SID outside the third DTLS packet; and
in response to receiving the destination port number, retrieving the SID from the payload of the third UDP packet;
retrieving the session key associated with the SID;
authenticating the third DTLS packet using the session key.

3. The method according to claim 1, wherein the SID includes a first segment and a second segment, and wherein the first segment contains an public IP address assigned by the NAT device to the device and the second segment contains port number and index, wherein the port number assigned by the NAT device to the device, the index is a random value assigned by the DTLS server.

4. The method according to claim 1, further comprising:
generating an unencrypted SID;
encrypting the unencrypted SID to form the SID.

5. A method performed by a device in communication via a private network with a Datagram Transport Layer Security (DTLS) server on a public network through a Network Address Translation (NAT) device, comprising:
generating a first DTLS packet to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151;
sending the first DTLS packet to the DTLS server through the NAT device;
receiving a second DTLS packet from the DTLS server in response to the first DTLS packet for initiating a DTLS session, wherein the second DTLS packet is encapsulated in a second UDP packet having a header and a payload, the header of the second UDP packet includes a source port number set to the destination port number and the payload of the second UDP packet includes the second DTLS packet and carries the SID outside the second DTLS packet;
extracting the SID from the payload of the second UDP packet.

6. The method according to claim 5, further comprising:
generating a third DTLS packet, wherein the third DTLS packet is encapsulated in a third UDP packet having a header and a payload, the header of the third UDP packet includes the destination port number and the payload of the third UDP packet includes the third DTLS packet and carries the SID outside the third DTLS packet;
sending the third DTLS packet to the DTLS server.

7. The method according to claim 6, further comprising:
entering into a sleep mode and then waking up from the sleep mode;
sending a fourth DTLS packet to the DTLS server through the NAT device, wherein the fourth DTLS packet is encapsulated in a fourth UDP packet having a header and a payload, the header of the fourth UDP packet includes the destination port number and the payload of the fourth UDP packet includes the fourth DTLS packet and carries the SID outside the fourth DTLS packet.

8. A Datagram Transport Layer Security (DTLS) server in communication via a public network with a device on a private network through a Network Address Translation (NAT) device, comprising:
a non-transitory memory storage comprising instructions; and
one or more processors in communicating with the memory, wherein the one or more processors execute the instructions to:
receive a first DTLS packet from the device to initiate a DTLS session with the DTLS server, wherein the first DTLS packet is encapsulated in a first User Datagram Protocol (UDP) packet having a header and a payload, the header of the first UDP packet includes a destination port number in an unregistered port number range of 1024 to 49151; and
in response to receiving the destination port number, assign a Session ID (SID) for the DTLS session between the device and the DTLS server, the SID having a length from 6 bytes to 132 bytes;
associate a session key for the DTLS session with the SID;
send a second DTLS packet to the device, wherein the second DTLS packet is encapsulated in a second UDP packet having a header and a payload, the header of the second UDP packet includes a source port number set to the destination port number, and the payload of the second UDP packet includes the second DTLS packet and carries the SID outside the second DTLS packet.

9. The DTLS server according to claim 8, wherein the one or more processors further execute the instructions to:
receive a third DTLS packet from the device, wherein the third DTLS packet is encapsulated in a third UDP packet having a header and a payload, the header of the third UDP packet includes the destination port number and the payload of the third UDP packet includes the third DTLS packet and carries the SID outside the third DTLS packet; and
in response to receiving the destination port number, retrieve the SID from the payload of the third UDP packet;
retrieve the session key associated with the SID;
authenticate the third DTLS packet using the session key.

10. The DTLS server according to claim 8, wherein the SID includes a first segment and a second segment, and wherein the first segment contains an public IP address assigned by the NAT device to the device and the second segment contains port number and index, wherein the port number assigned by the NAT device to the device, the index is a random value assigned by the DTLS server.

11. The DTLS server according to claim 8, wherein the one or more processors further execute the instructions to:
generate an unencrypted SID;
encrypt the unencrypted SID to form the SID.
